(19) United States
(12) Patent Application Publication
(10) Pub. No.: US 2009/0070611 A1
(43) Pub. Date: Mar. 12, 2009

(54) Managing Computer Power Consumption In A Data Center

(75) Inventors: Fred A. Bower, III, Durham, NC (US); Raymond M. Clemo, Raleigh, NC (US); Beth F. Loebach, Raleigh, NC (US); Gregory J. McKnight, Chapel Hill, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/854,398

(22) Filed: Sep. 12, 2007

(51) Int. Cl. G06F 1/32

(52) U.S. Cl. 713/322; 713/320

(57) ABSTRACT

Methods, systems, and computer program products are provided for managing computer power consumption in a data center. Embodiments include monitoring aggregate power consumption of a plurality of computers in the data center, each of the computers being supplied power individually from a shared circuit in the data center; determining whether the aggregate power consumption exceeds a predetermined maximum threshold; if the aggregate power consumption exceeds the predetermined maximum threshold, selecting a number of computers for throttling in dependence upon priority; and throttling-down the selected computers, reducing the aggregate power consumption to a level below the predetermined maximum threshold. Some embodiments may also include determining whether the aggregate power consumption is below a predetermined minimum threshold; if the aggregate power consumption is below the predetermined minimum threshold, selecting a number of computers for throttling in dependence upon priority; and throttling-up the selected computers, increasing the aggregate power consumption to a level above the predetermined minimum threshold.

### BACKGROUND OF THE INVENTION

1. Field of the Invention

The field of the invention is data processing, or, more specifically, methods, apparatus, and products for managing computer power consumption in a data center.

2. Description of Related Art

Conventional data centers include many computers and all of those computers consume power. Because power is a significant expense managing power is an important consideration for systems administrators of data centers. Another important consideration for systems administrators of data centers is that often current safety regulations preclude configuring the computers of the data center such that the total maximum power consumption may exceed the input circuit power available. Under such safety regulations it is not possible to oversubscribe the circuit power by configuring a number of computers such that total power may be greater than the total circuit. There is therefore an ongoing need for improvement in managing computer power consumption in a data center.

### SUMMARY OF THE INVENTION

Methods, systems, and computer program products are provided for managing computer power consumption in a data center. Embodiments include monitoring aggregate power consumption of a plurality of computers in the data center, each of the computers being supplied power individually from a shared circuit in the data center; determining whether the aggregate power consumption exceeds a predetermined maximum threshold; if the aggregate power consumption exceeds the predetermined maximum threshold, selecting a number of computers for throttling in dependence upon priority; and throttling-down the selected computers, reducing the aggregate power consumption to a level below the predetermined maximum threshold. Some embodiments may also include determining whether the aggregate power consumption is below a predetermined minimum threshold; if the aggregate power consumption is below the predetermined minimum threshold, selecting a number of computers for throttling in dependence upon priority; and throttling-up the selected computers, increasing the aggregate power consumption to a level above the predetermined minimum threshold.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for managing computer power consumption in a data center according to embodiments of the present invention.

FIG. 2 sets forth a block diagram of automated computing machinery comprising an exemplary power consumption managing computer useful in managing computer power consumption in a data center according to embodiments of the present invention.

FIG. 3 sets forth a flow chart illustrating an exemplary method for managing computer power consumption in a data center according to embodiments of the present invention.

FIG. 4 sets forth a flow chart illustrating an exemplary flow chart illustrating establishing the maximum threshold in dependence upon power objectives for the data center.

FIG. 5 sets forth a flow chart illustrating additional exemplary aspects of a method for managing computer power consumption in a data center according to embodiments of the present invention that includes throttling-up selected computers.

### DETAILED DESCRIPTION OF EXEMPLARY EMBODIMENTS

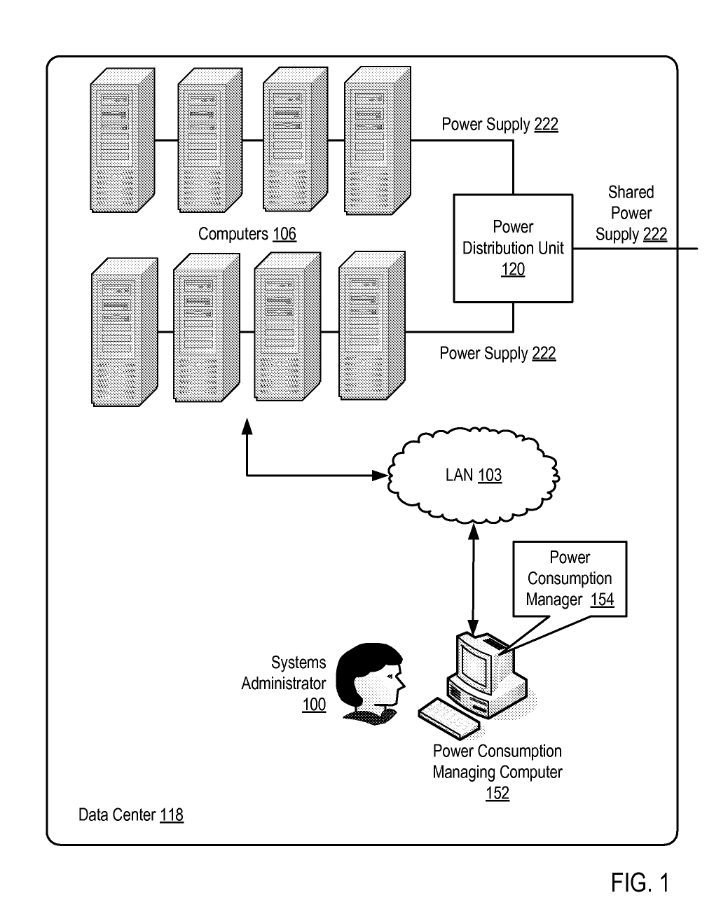

Exemplary methods, systems, and products for managing computer power consumption in a data center in accordance with the present invention are described with reference to the accompanying drawings, beginning with FIG. 1. FIG. 1 sets forth a network diagram of a system for managing computer power consumption in a data center according to embodiments of the present invention. The system of FIG. 1 includes a data center (118). A data center is a centralized repository, either physical or virtual, for the storage, management, and dissemination of data and information organized around a particular subject or pertaining to a particular business. A data center may exist within an organization's facilities or may be maintained as a specialized facility. Data centers vary in size from buildings of servers to a server rooms to even computer closets.

The data center (118) of FIG. 1 includes a plurality of prioritized computers (106) connected to a power consumption managing computer (152) through a local area network (‘LAN’) (103). The plurality of computers are prioritized for throttling-down or throttling-up to manage power consumption in the data center. The plurality of computers may be prioritized dynamically in dependence upon current operating conditions such as applications currently running on each computer, tasks of an executing application currently running on each computer, and so on as will occur to those of skill in the art. The plurality of computers alternatively may be previously prioritized and such priorities may remain static until the computers are re-prioritized.

In the example of FIG. 1 each of the computers (106) is being supplied power (222) individually from a shared circuit in the data center (118) that receives a shared power supply (222). That is, each computer is independently supplied power from a common circuit receiving shared electrical supply within the data center.

The example of FIG. 1 also includes a power distribution unit (120). The power distribution unit of FIG. 1 (120) has a dedicated circuit for measuring the aggregate power consumption (120) of the computers (106) and providing the measured aggregate power consumption (120) to a power consumption manager (154).

The power consumption managing computer (152) of FIG. 1 has installed upon it a power consumption manager (154), computer program instructions for managing computer power consumption in the data center (118) according to embodiments of the present invention. The power consumption manager (154) includes computer program instructions that are capable of monitoring aggregate power consumption of a plurality of computers (106) in the data center (118); determining whether the aggregate power consumption exceeds a predetermined maximum threshold; if the aggregate power consumption exceeds a predetermined maximum threshold, selecting a number of computers for throttling in dependence upon priority; and throttling-down the selected computers, reducing the aggregate power consumption to a level below the predetermined maximum threshold.

The power consumption manager (154) of FIG. 1 also includes computer program instructions capable of continuing to monitor the aggregate power consumption of the plurality of computers (106) in the data center (118); determining whether the aggregate power consumption is below a predetermined minimum threshold; if the aggregate power consumption is below a predetermined minimum threshold, selecting a number of computers for throttling in dependence upon priority; and throttling-up the selected computers, increasing the aggregate power consumption to a level above the predetermined minimum threshold.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

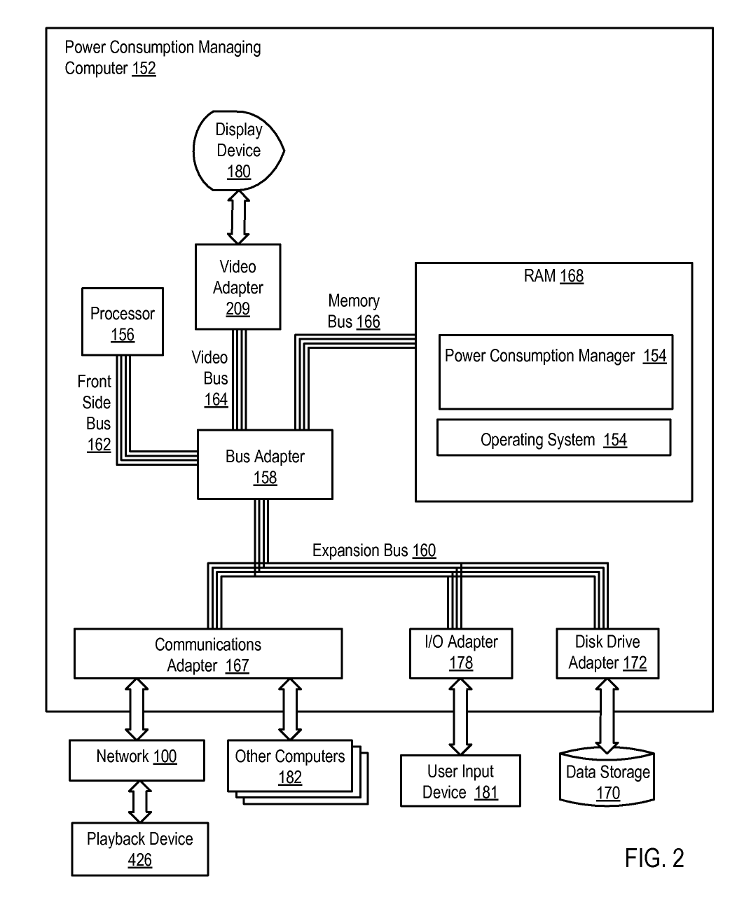

Managing computer power consumption in a data center in accordance with the present invention is generally implemented with computers, that is, with automated computing machinery. For further explanation, therefore, FIG. 2 sets forth a block diagram of automated computing machinery comprising an exemplary power consumption managing computer (152) useful in managing computer power consumption in a data center according to embodiments of the present invention. The power consumption managing computer (152) of FIG. 2 includes at least one computer processor (156) or ‘CPU’ as well as random access memory (168) (‘RAM’) which is connected through a high speed memory bus (166) and bus adapter (158) to processor (156) and to other components of the power consumption managing computer (152).

Stored in RAM (168) is a power consumption manager (154), a module of computer program instructions for managing computer power consumption in a data center in accordance with embodiments of the present invention. The power consumption manager (154) includes computer program instructions capable of monitoring aggregate power consumption of a plurality of computers in the data center; determining whether the aggregate power consumption exceeds a predetermined maximum threshold; if the aggregate power consumption exceeds a predetermined maximum threshold, selecting a number of computers for throttling in dependence upon priority; and throttling-down the selected computers, reducing the aggregate power consumption to a level below the predetermined maximum threshold. The power consumption manager (154) of FIG. 2 also includes computer program instructions capable of determining whether the aggregate power consumption is below a predetermined minimum threshold; if the aggregate power consumption is below a predetermined minimum threshold, selecting a number of computers for throttling in dependence upon priority; and throttling-up the selected computers, increasing the aggregate power consumption to a level above the predetermined minimum threshold.

Also stored in RAM (168) is an operating system (154). Operating systems useful in managing computer power consumption in a data center according to embodiments of the present invention include UNIX™, Linux™, Microsoft XP™, AIX™, IBM's i5/OS™, and others as will occur to those of skill in the art. The operating system (154) and power consumption manager (154) in the example of FIG. 2 are shown in RAM (168), but many components of such software typically are stored in non-volatile memory also, such as, for example, on a disk drive (170).

The power consumption managing computer (152) of FIG. 2 includes disk drive adapter (172) coupled through expansion bus (160) and bus adapter (158) to processor (156) and other components of the power consumption managing computer (152). Disk drive adapter (172) connects non-volatile data storage to the power consumption managing computer (152) in the form of disk drive (170). Disk drive adapters useful in computers for managing computer power consumption in a data center according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example power consumption managing computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example power consumption managing computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary power consumption managing computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for managing computer power consumption in a data center according to embodiments of the present invention include modems for wired dial-up communications, Ethernet (IEEE 802.3) adapters for wired data communications network communications, and 802.11 adapters for wireless data communications network communications.

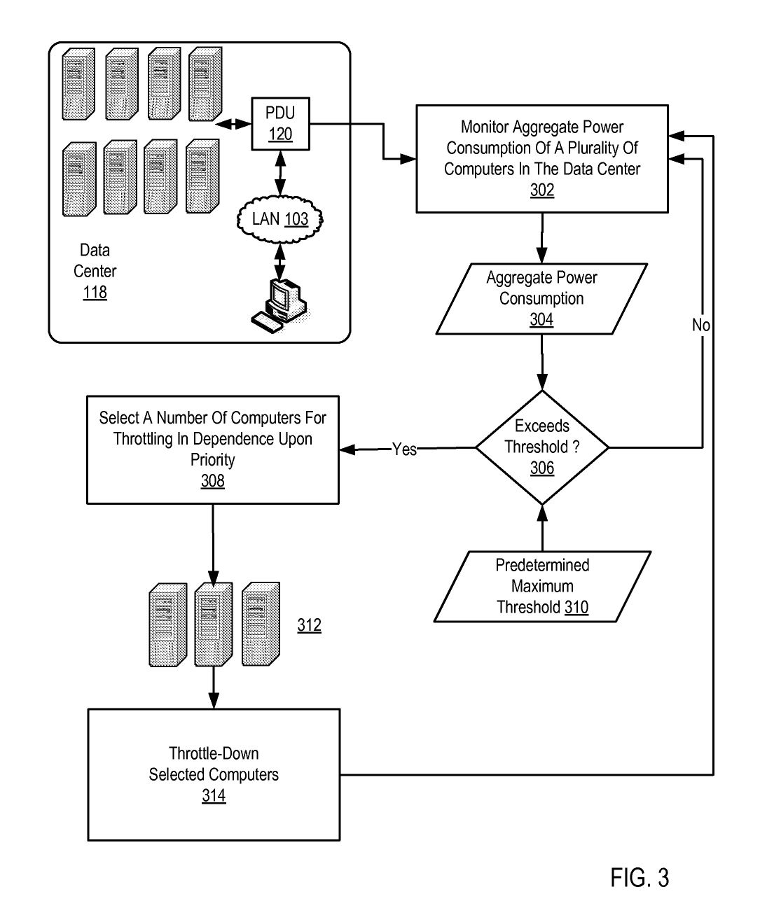

For further explanation, FIG. 3 sets forth a flow chart illustrating an exemplary method for managing computer power consumption in a data center according to embodiments of the present invention. In the example of FIG. 3 each of the computers has independent power supply within the data center. That is, each computer is independently supplied power from a common circuit within the data center.

The method of FIG. 3 includes monitoring (302) aggregate power consumption (304) of a plurality of computers in the data center (118). Monitoring (302) aggregate power consumption (304) of a plurality of computers in the data center (118) may be carried out by receiving the measurement of power consumption from power distribution units (120) of racks of computers of the data center. Such power distribution units may include dedicated power measuring circuits that measure power consumption and such power distribution units may be connected for data communications to a power consumption manager which aggregates all the power consumption values of all the computers being monitored.

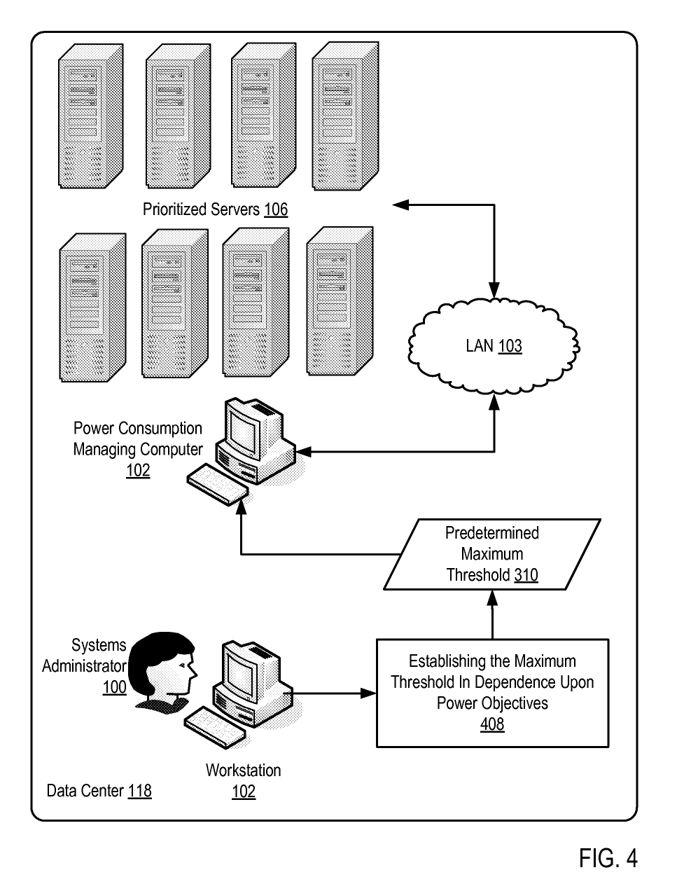

The method of FIG. 3 includes determining (306) whether the aggregate power consumption (304) exceeds a predetermined maximum threshold (310). Determining (306) whether the aggregate power consumption (304) exceeds a predetermined maximum threshold (310) may be carried out by comparing the aggregate power consumption with the predetermined maximum threshold. Such a predetermined maximum threshold may be established by a systems administrator of the data center to meet power objectives of the data center as discussed below with reference to FIG. 4.

If the aggregate power consumption (304) does not exceed a predetermined maximum threshold (310), the method of FIG. 3 continues to monitor the aggregate power consumption of the computers of the data center (118). If the aggregate power consumption (304) exceeds a predetermined maximum threshold (310), the method of FIG. 3 includes selecting (308) a number of computers (312) for throttling in dependence upon priority. Selecting (308) a number of computers (312) for throttling in dependence upon priority may be carried out by selecting a number of computers in dependence upon data processing value rules. Data processing value rules are rules established to select computers for throttling such that the throttling-down of those computers has the least effect on the computational ability of the data center. In some cases, data processing value rules may dictate that a certain computers already designated as low priority are to be throttled-down when the aggregate power consumption exceeds the predetermined maximum threshold.

Alternatively, data processing value rules may be configured for dynamic selection of computers for throttling. Such data processing value rules are capable of assigning priorities to the computers of the data center in dependence upon the applications currently running on the computers and selecting a number of computers in dependence upon the assigned priorities. Assigning priorities to the computers of the data center in dependence upon the applications currently running on the computers may include assigning priorities in dependence upon the kind of application running on the computer, the actual computations currently being carried out by the computer, or other application attributes as will occur to those of skill in the art.

The method of FIG. 3 includes throttling-down (314) the selected computers (312). Throttling-down the selected computers may be carried out by reducing the CPU clock speed of one or more of the selected computers. Throttling-down the selected computers also may be carried out by reducing the data communications bus clock speed of one or more of the selected computers. Data communications bus clock speeds that may be reduced to throttle-down the selected computers include I/O bus clock speeds, memory bus clock speeds, and so on as will occur to those of skill in the art.

After throttling-down (314) the selected computers (312), the method of FIG. 3 continues to monitor the aggregate power consumption of the computers in the data center. The method of FIG. 3 may be carried out iteratively until throttling-down selected computers results in reducing the aggregate power consumption to a level below the predetermined maximum threshold (310).

The method of FIG. 3 allows the highest priority computers to be protected from throttling unless lower priority computers have already been throttled to their maximum allowed rate as determined by the data center systems administrator. This technique protects the use of the high priority computers as best as possible within the constraints of the predetermined power usage limits.

For further explanation, FIG. 4 sets forth a flow chart illustrating an exemplary flow chart illustrating establishing (406) the maximum threshold (310) in dependence upon power objectives for the data center. Establishing (406) the maximum threshold (310) in dependence upon power objectives for the data center in the example of FIG. 4 is carried out by a systems administrator (100) of the data center (118) to meet one or more power objectives of the data center and a power consumption manager installed on the power consumption managing computer (102) is capable of receiving such an established predetermined maximum threshold. Power objectives may include energy consumption objectives to reduce total energy consumption of the data center thereby reducing total costs spent on energy. Power objectives may also take into consideration physical limitations set by the physical implementation of the data center. That is, there may be a maximum power that can be delivered by the wired infrastructure of the data center.

Power objectives may also include oversubscription objectives. Oversubscription of a power circuit occurs when the possible aggregate power consumption of the computers powered by the circuit of the data center exceeds the rating of the circuit powering the computers. Establishing a threshold below the rating of the power circuit allows the circuit to be oversubscribed with computers whose aggregate maximum power consumption otherwise could exceed the rating of the circuit and also provides the needed protection for the circuit. That is, if the aggregate power consumption of the computers in the data center does not exceed the predetermined threshold the power circuit the operation of the computers will remain unaffected regardless of the subscription level of the data center and if the aggregate power consumption of the computers in the data center does exceed the predetermined threshold selected computers will be throttled-down.

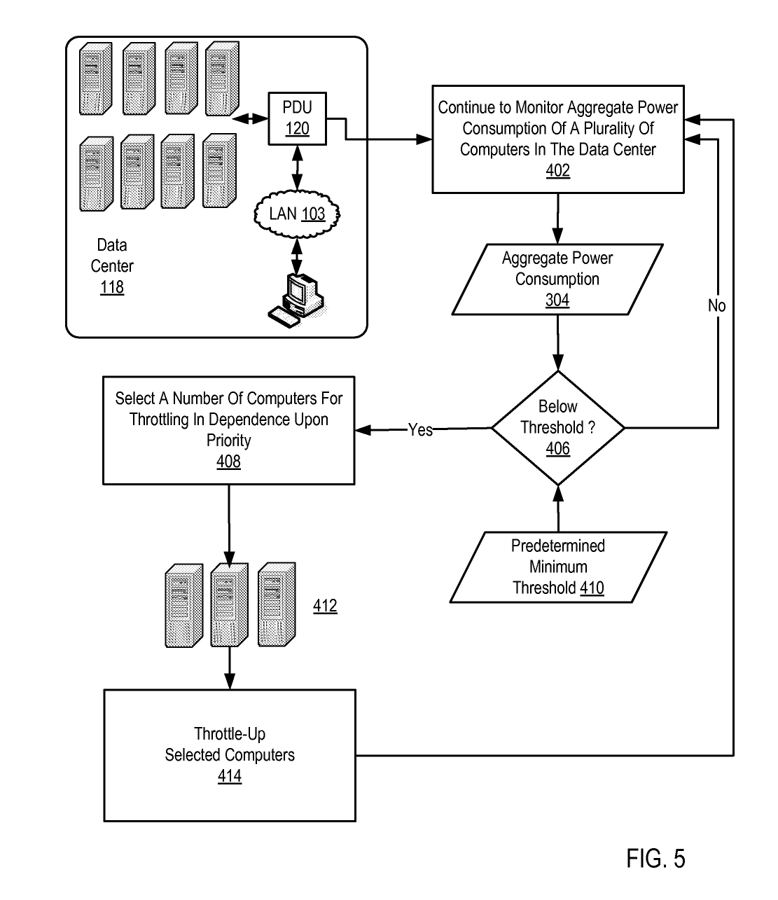

Once the aggregate power consumption of the computers of the data center has been reduced below the predetermined maximum threshold, continuing the operation of throttled-down computers may result in unnecessary energy conservation at the expense of productivity of the data center. For further explanation, therefore, FIG. 5 sets forth a flow chart illustrating additional exemplary aspects of method for managing computer power consumption in a data center according to embodiments of the present invention that includes throttling-up selected computers. The method of FIG. 5 includes continuing to monitor (402) the aggregate power consumption (304) of the plurality of computers in the data center and determining (406) whether the aggregate power consumption (406) is below a predetermined minimum threshold (410). Determining (406) whether the aggregate power consumption (406) is below a predetermined minimum threshold (410) may be carried out by comparing the aggregate power consumption with the predetermined minimum threshold. Such a predetermined minimum threshold may be established by a systems administrator of the data center to meet power objectives of the data center in the same manner as discussed above with reference to FIG. 4.

If the aggregate power consumption (304) is below a predetermined minimum threshold (410), the method of FIG. 5 includes selecting (408) a number of computers (412) for throttling in dependence upon priority. Selecting (408) a number of computers (412) for throttling in dependence upon priority may be carried out by selecting a number of computers in dependence upon data processing value rules as discussed above with reference to FIG. 3. Such data processing value rules may dictate the same set of computers or a different set of computers for throttling-up than the computers selected for throttling-down according to the method of FIG. 3.

In some cases, data processing value rules may dictate that a certain computers already designated as high priority are to be throttled up when the aggregate power consumption exceeds the predetermined minimum threshold. Alternatively, data processing value rules may be configured for dynamic selection of computers for throttling as mentioned above with reference to FIG. 3.

The method of FIG. 5 also includes throttling-up (414) the selected computers (412). Throttling-up the selected computers may be carried out by increasing the CPU clock speed of one or more of the selected computers, increasing the data communications bus clock speeds of one or more of the selected computers, or in other ways as will occur to those of skill in the art.

After throttling-up (414) the selected computers (312), the method of FIG. 3 continues to monitor the aggregate power consumption of the computers in the data center. The method of FIG. 4 may be carried out iteratively until throttling-up the selected computers results in increasing the aggregate power consumption to a level above the predetermined minimum threshold (410).

Exemplary embodiments of the present invention are described largely in the context of a fully functional computer system for managing computer power consumption in a data center. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for managing computer power consumption in a data center, the method comprising:
monitoring aggregate power consumption of a plurality of computers in the data center, each of the computers being supplied power individually from a shared circuit in the data center;
determining whether the aggregate power consumption exceeds a predetermined maximum threshold;
if the aggregate power consumption exceeds the predetermined maximum threshold, selecting a number of computers for throttling in dependence upon priority; and
throttling-down the selected computers, reducing the aggregate power consumption to a level below the predetermined maximum threshold.

2. The method of claim 1 further comprising:
determining whether the aggregate power consumption is below a predetermined minimum threshold;
if the aggregate power consumption is below the predetermined minimum threshold, selecting a number of computers for throttling in dependence upon priority; and
throttling-up the selected computers, increasing the aggregate power consumption to a level above the predetermined minimum threshold.

3. The method of claim 1 wherein throttling-down the selected computers further comprises reducing a CPU clock speed of one or more of the selected computers.

4. The method of claim 1 wherein throttling-down the selected computers further comprises reducing a data communications bus clock speed of one or more of the selected computers.

5. The method of claim 1 wherein selecting a number of computers for throttling in dependence upon priority further comprises selecting a number of computers in dependence upon data processing value rules.

6. The method of claim 1 further comprising establishing the maximum threshold in dependence upon power objectives for the data center.

7. A system for managing computer power consumption in a data center, the apparatus comprising a computer processor, a computer memory operatively coupled to the computer processor, the computer memory having disposed within it computer program instructions capable of:
monitoring aggregate power consumption of a plurality of computers in the data center, each of the computers being supplied power individually from a shared circuit in the data center;
determining whether the aggregate power consumption exceeds a predetermined maximum threshold;
if the aggregate power consumption exceeds the predetermined maximum threshold, selecting a number of computers for throttling in dependence upon priority; and
throttling-down the selected computers, reducing the aggregate power consumption to a level below the predetermined maximum threshold.

8. The system of claim 7 wherein the computer memory also has disposed within it computer program instructions capable of:
determining whether the aggregate power consumption is below a predetermined minimum threshold;
if the aggregate power consumption is below the predetermined minimum threshold, selecting a number of computers for throttling in dependence upon priority; and
throttling-up the selected computers, increasing the aggregate power consumption to a level above the predetermined minimum threshold.

9. The system of claim 7 wherein computer program instructions capable of throttling-down the selected computers further comprise computer program instructions capable of reducing a CPU clock speed of one or more of the selected computers.

10. The system of claim 7 wherein computer program instructions capable of throttling-down the selected computers further comprise computer program instructions capable of reducing a data communications bus clock speed of one or more of the selected computers.

11. The system of claim 7 wherein computer program instructions capable of selecting a number of computers for throttling in dependence upon priority further comprise computer program instructions capable of selecting a number of computers in dependence upon data processing value rules.

12. The system of claim 7 wherein the computer memory also has disposed within it computer program instructions capable of receiving the maximum threshold in dependence upon power objectives for the data center.

13. A computer program product for managing computer power consumption in a data center, the computer program product disposed in a computer readable medium, the computer program product comprising computer program instructions capable of:
monitoring aggregate power consumption of a plurality of computers in the data center, each of the computers being supplied power individually from a shared circuit in the data center;
determining whether the aggregate power consumption exceeds a predetermined maximum threshold;
if the aggregate power consumption exceeds the predetermined maximum threshold, selecting a number of computers for throttling in dependence upon priority; and
throttling-down the selected computers, reducing the aggregate power consumption to a level below the predetermined maximum threshold.

14. The computer program product of claim 13 further comprising computer program instructions capable of:
determining whether the aggregate power consumption is below a predetermined minimum threshold;
if the aggregate power consumption is below the predetermined minimum threshold, selecting a number of computers for throttling in dependence upon priority; and
throttling-up the selected computers, increasing the aggregate power consumption to a level above the predetermined minimum threshold.

15. The computer program product of claim 113 wherein computer program instructions capable of throttling-down the selected computers further comprise computer program instructions capable of reducing a CPU clock speed of one or more of the selected computers.

16. The computer program product of claim 13 wherein computer program instructions capable of throttling-down the selected computers further comprise computer program instructions capable of reducing a data communications bus clock speed of one or more of the selected computers.

17. The computer program product of claim 13 wherein computer program instructions capable of selecting a number of computers for throttling in dependence upon priority further comprise computer program instructions capable of selecting a number of computers in dependence upon data processing value rules.

18. The computer program product of claim 13 further comprising computer program instructions capable of receiving the maximum threshold in dependence upon power objectives for the data center.

19. The computer program product of claim 13 wherein the computer readable medium comprises a recordable medium.

20. The computer program product of claim 13 wherein the computer readable medium comprises a transmission medium.
